(19) United States
(12) Patent Application Publication
(10) Pub. No.: US 2024/0420546 A1
(43) Pub. Date: Dec. 19, 2024

(54) TIERED BONUS GAME METHODS

(71) Applicant: IGT, Las Vegas, NV (US)

(72) Inventors: Roman Souza, Sparks, NV (US); Dwayne Nelson, Las Vegas, NV (US); Jackie Alvarez, Las Vegas, NV (US)

(21) Appl. No.: 18/210,188

(22) Filed: Jun. 15, 2023

(51) Int. Cl. G07F 17/32

(52) U.S. Cl. CPC G07F 17/3267; G07F 17/3213; G07F 17/3293

(57) ABSTRACT

The present disclosure is directed to increasing player engagement with the electronic game through the use of tiered bonuses. According to one embodiment, a gaming system can execute an electronic game in a first mode, detect an occurrence of an event in the first mode of the electronic game, and execute the electronic game in a second mode based on the detected occurrence of the event, wherein the second mode of the plurality of modes comprises a tier of a plurality of tiers. A tier determination rule can be applied to game play information for the electronic game executed in the second mode and the tier of the plurality of tiers for the second mode can be updated based on the applied tier determination rule. An indication of the updated tier of the plurality of tiers for the second mode can be provided.

### BACKGROUND

The present disclosure is generally directed to operation of an electronic game conducted on a gaming system and, in particular, toward increasing player engagement with the electronic game through the use of tiered bonuses.

In a casino environment, games which provide a story and/or a sense of progression can increase player engagement. Increased player engagement in turns leads to increased use of the game and revenues for the operator of the casino. Thus, rather than providing a static game with wins or losses, there is a need to provide a sense of progress through the game, especially in a way that connects to the game in a logical and entertaining way.

### BRIEF SUMMARY

Embodiments of the present disclosure are directed to increasing player engagement with the electronic game through the use of tiered bonuses. According to one embodiment, a gaming system can comprise a processor and a memory coupled with and readable by the processor. The memory can store therein a set of instructions which, when executed by the processor, causes the processor to execute an electronic game in a first mode of the plurality of modes, detect an occurrence of an event in the first mode of the electronic game, and execute the electronic game in a second mode of the plurality of modes based on the detected occurrence of the event, wherein the second mode of the plurality of modes comprises a tier of a plurality of tiers. For example, the first mode can comprise a base play mode of the electronic game and the second mode can comprise a bonus play mode. The electronic game can comprise, for example, an electronic slots game, a video poker game, or any of a variety of other electronic games.

A tier determination rule can be applied to game play information for the electronic game executed in the second mode and the tier of the plurality of tiers for the second mode can be updated based on the applied tier determination rule. An indication of the updated tier of the plurality of tiers for the second mode can be provided. The gaming system can further comprise a display device coupled with the processor and providing the indication of the updated tier of the plurality of tiers for the second mode can comprise presenting a graphical indication of the updated tier of the display device. For example, the graphical indication can be related to a theme of the electronic game executed in the first mode. Additionally, or alternatively, the graphical indication can comprise an animation.

According to another embodiment, a gaming system can comprise a display device, a processor coupled with the display device, and a memory coupled with and readable by the processor. The memory can store therein a set of instructions which, when executed by the processor, causes the processor to execute an electronic game in a first mode of a plurality of modes. The plurality of modes can comprise the first mode and a second mode of operation of the electronic game and the second mode can comprise a plurality of tiers. The instructions can further cause the processor to provide a graphical representation of execution of the electronic game in the first mode through a first region of the display device, provide a graphical representation of the second mode of operation of the electronic game through a second region of the display device, detect a current state of the electronic game in the first mode of the electronic game, execute the electronic game in a second mode of the plurality of modes based on the detected state of the electronic game, and provide a graphical representation of execution of the electronic game in the second mode through the first region of the display device. For example, the state of the electronic game in the first mode can comprise a win state.

The instructions can further cause the processor to apply a tier determination rule to game play information for the electronic game executed in the second mode and update the tier of the plurality of tiers for the second mode based on the applied tier determination rule. Updating the tier of the plurality of tiers can comprise incrementing the tier of the plurality of tiers or decrementing the tier of the plurality of tiers. The instructions can further cause the processor to provide a graphical representation of the updated tier of the plurality of tiers for the second mode through the second region of the display device.

For example, the electronic game can comprise an electronic slots game, the second mode of the plurality of modes can comprise a bonus game mode, and the game play information for the electronic game executed in the second mode comprises a number of free spins in the bonus game mode. Additionally, or alternatively, the game play information for the electronic game executed in the second mode can comprise an amount of time in the second mode, a speed of play for the electronic game in the second mode, a result of the electronic game executed in the second mode, etc.

According to yet another embodiment, a method of executing an electronic game on a gaming system can comprise executing the electronic game in a first mode of a plurality of modes. The plurality of modes can comprise the first mode and a second mode of operation of the electronic game and the second mode can comprise a plurality of tiers. A graphical representation of execution of the electronic game in the first mode can be presented through a first region of a display device of a gaming system. A determination of a current tier of the plurality of tiers for the second mode can be made. Determining the current tier of the plurality of tiers of the second mode can comprise requesting, from a host system, the current tier of the plurality of tiers of the second mode. A graphical representation of the second mode of operation of the electronic game can be presented through a second region of the display device. The graphical representation of the second mode of operation of the electronic game can comprise a representation of the current tier of the plurality of tiers.

A current state of the electronic game in the first mode of the electronic game can be detected and the electronic game can be executed in a second mode of the plurality of modes based on the detected state of the electronic game in the first mode. A graphical representation of execution of the electronic game in the second mode can be presented through the first region of the display device, a tier determination rule can be applied to game play information for the electronic game executed in the second mode, and the tier of the plurality of tiers for the second mode can be updated based on the applied tier determination rule. For example, a paytable for the second mode of the plurality of modes of the electronic game can be updated based on the determined current tier of the second mode. Updating the paytable for the second mode can comprise changing win categories of the paytable or changing a payout of the paytable. A graphical representation of the updated tier of the plurality of tiers for the second mode can be provided through the second region of the display device.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary gaming system according to one embodiment of the present disclosure.

FIG. 3 is a block diagram illustrating additional details of components of an exemplary host system according to one embodiment of the present disclosure.

FIG. 4 is a flowchart illustrating an exemplary process for providing tiered bonuses in an electronic game according to one embodiment of the present disclosure.

FIG. 5 is a flowchart illustrating an exemplary process for providing tiered bonuses in an electronic game according to another embodiment of the present disclosure.

### DETAILED DESCRIPTION

Embodiments of the present disclosure will be described in connection with a tiered bonus display system for an electronic game executed on a gaming system. According to one embodiment, the tiers advance during a bonus game and increase the excitement and anticipation of the player. This is achieved by a growing tier display along with synchronization with the bonus display to reinforce elements of the game and win amounts. Embodiments can include, but are not limited to, a slot bonus game played at an Electronic Gaming Machine (EGM), Video Lottery Terminal (VLT), online or mobile. Embodiments are applicable to games with real money but also for games played socially and not for real money wins. Embodiments can also be applied to other types of games including, but not limited to, keno, poker and other gambling or games for entertainment.

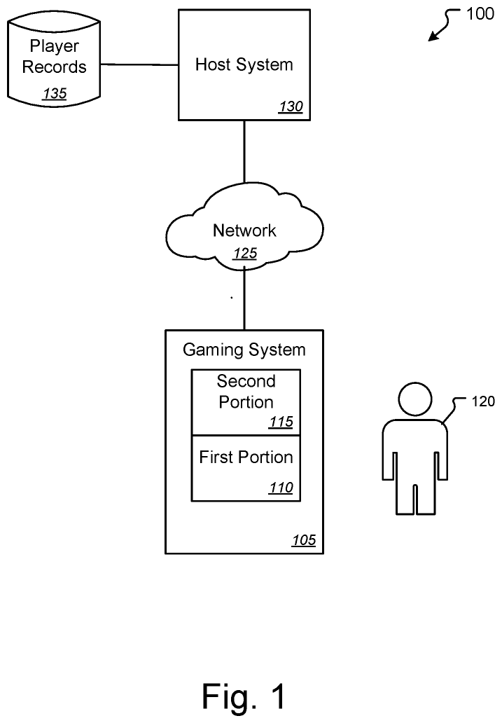

FIG. 1 is a block diagram illustrating an exemplary environment in which embodiments of the present disclosure can be implemented. As illustrated in this example, the environment 100 can include a gaming system 105 having a display device logically divided into portions onto which different content can be presented. For example, the display can include a first portion on which an interface for an electronic game executed by the gaming system 105 can be presented. The display can also include a second portion 115 onto which another interface can be provided. According to embodiments described herein, this second portion 115 can be used to present an indicator of a tier in which the game is being played.

For example, the first portion 110 can present graphics representing a game, e.g., spinning reels for a slots game. The game can be operated in a base mode in which the player initiates spins and views results thereof. The game may also have a second, bonus mode in which free spins can be played. This second, bonus mode may have a number of tiers. As used herein, a tier is a term for a progressive state of the game. As the bonus mode play progresses, the game state can move to a higher tier.

The tier can be represented in a tier state or display state presented in the second portion 115 of the display of the gaming system 105. For example, a bonus game could be at tier 2 represented in a manner consistent with a theme for the electronic game, e.g., a man's sword is withdrawn and he is using it in a gladiator-themed game. When the free spins hit a “sword” symbol the tier display can animate the sword in the tier display and in the slot reels. In this manner the tier state has changed because it is now animating the sword but remains at level 2. Some states are not possible at certain tiers. For example, the sword animation described might not be available at tier 1.

The tier display, i.e., presented on the second portion 115 of the display of the gaming system 105, can be the visual representation of the tier level and/or state. This can be separated from the bonus game display such as the slot reels in the free spin example which can be presented on the first portion 110 of the display of the gaming system. The tier display can be related to the bonus game display artistically, e.g., it can be related to or based on the theme of the game.

In a base mode, a game such a slots can include one or more slot symbols on a payline that can trigger the bonus or one or more slot symbols scattered across the reels can trigger the bonus. In one embodiment the symbols that trigger the bonus can determine some of the state of the tier for the bonus game. For example, if the base game triggers with three “man symbols,” then the tier for the bonus can start with the man. If the base game is triggered with three “woman symbols,” then the tier state of the bonus would be the woman.

As the free spins advance the bonus game can advance through tiers based on some rules. In one embodiment, the game can advance tiers per unit of time or number of spins. In another embodiment the tiers can advance based on the wins in the bonus games, categories won in the bonus, and/or speed at which the bonus is played.

As the tiers advance the elements of the visual representation of the tier can advance. In one example, a character can start out with less detail, color or clarity, e.g., as a silhouette, and can become more detailed and focused as the player advances through tiers in order to provide excitement. In one embodiment the tier display element, such as a man, can move from a two-dimensional element to a more three-dimensional element or an element with more depth and shadows. In one embodiment the tier display, such as the man, can move from a cartoonish image to a more realistic image as the tier level advances.

In one embodiment sounds of the game can become clearer, change in volume, change in type, etc. as the tier level advances. For example, the character may be speaking periodically but is muffled at tier 1, but very clear and loud at tier 3.

In one embodiment, elements of the character can begin to come into focus, highlight, flash, create sounds and otherwise interact with the same or similar elements on the free spin game. For example, the character's face could wink and cause the slot symbols of the character's face to also wink. In another example, the character's sword could sparkle, shake or animate and the symbols on the reel also begin to do the same. In the example game shown, the red balls in the pot of gold may be a key element of the game so they can interact with the slot reels at some point to reinforce the importance of the red balls.

In one embodiment the game speed can increase with tier. For example, at tier 1 the reels might take three seconds to spin and stop and spin slowly, but at tier 3 they may spin and stop in one second and/or spin very fast. In other embodiments the reels could change speed in other manners including slowing down, stuttering, locking, etc.

In one embodiment the tier structure can have multiple outcomes and advancing through the tiers can reveal the direction and final outcome. For example, the tier structure might start with three vaguely defined characters because the slot game has a male figure, a female figure, and a dragon. The player cannot determine which one will come into focus. Each figure could have some related game element, such as a slot symbol or bonus animation. As the tier advances one or more of the characters can come more into focus while the others do not. In this way game elements can be obfuscated from the player and can be brought into focus as the bonus game unfolds. In a similar embodiment, the character might wear a mask or some other covering clothing such that the player cannot discern the identity immediately but it can be slowly revealed as the tier level increases.

In one embodiment the tier can advance based on a multiplier. The multiplier could have been won in the base game and/or the free spins. In this manner, the tier can advance faster based on the multipliers accumulated by the player. In one embodiment the multiplier can be accumulated in the base game such that the player enters the bonus with an accelerated tier advancement.

In one embodiment the slot game display can glow or animate with tier level. For example, the slot reels could glow in a synchronized manner with the tier display.

In one embodiment the game display can adjust in size or dimensions with tier level. For example, the slot reels could grow with tier level. The game display could also change position such as the slot reels moving up towards the middle of the screen or changing position in some manner. In one embodiment the slot reels can shrink in size and move such that the tier display becomes more and more prominent during as the tier level increase and therefore increases the effect of the tier display (e.g., player anticipation).

In one embodiment the game sounds could get louder, change, play longer or play additional sounds with tier.

In one embodiment the game animations could change, play longer or play additional animations with tier.

To implement such tier progression, the gaming system 105 can wait for a bonus event such as a wager, win of a certain category, win of a certain amount, win over a certain threshold, a period of time, win over a period of time, and near miss, a loss, a certain symbol, a certain player choice, or just randomly. Of course, one or more of these could be used to trigger the logic. More than one matching element can be selected in other embodiments. In one embodiment, the higher the tier level the more matching elements may be selected. For example, at tier level 1, one game element from the tier display interacts with the slot reels but at tier level 2, two game elements interact with the slot reels.

In one embodiment the tier display in the second portion 115 of the display can be a representation of the symbols or items that win the top prize or progressive prize. In the examples given, imagine that hitting five of the “man” symbols on the reels win the progressive of $1 million. It makes sense for the man to advance and come into focus because it lets the player know they are getting closer to, or have more chances to win, the progressive prize.

According to one embodiment, the player can take an action, e.g., spin the reels, and the gaming system 105 can evaluate the win. Based on the tier rules, e.g., amount won, play speed, category won, etc., the tier logic can apply to change or update the tier display. Then the tier display in the second portion 115 and game display in the first portion 110 can animate together such as highlighting the coins in the tier display when the coins on the slot display are animating. The final animation can happen all the time, even on the next spin such that the tier display is continually animating, or the tier display could display synchronously win the slot display and then stop the synchronization when the next spin starts.

In one embodiment the tier display can animate or react at a random point in time but consistent with the current tier level and state.

In some embodiments, an increasing tier level can be used to build anticipation with the player. However, in some embodiments the tier level could decrease to indicate the player is moving away from the desired state. For example, the tier level could decrease because of a slow rate of play by the player, the player not winning enough, the player not hitting the right win categories in the bonus games, etc. The idea is to have the tier display indicate that the player should play faster and try to win more or more categories.

In one embodiment the player enters the bonus at the maximum tier and the tier works backwards thus showing the player the maximum state/win first and then moving away.

In one embodiment as the tier advances the monetary elements of the game can change. This combines the advancing feeling of the tier with the monetary gain for the player. The monetary elements of the game could be the win display, sometimes called the win “meter,” player balance or “credit meter,” line win indicator or progressive displays.

In one embodiment the player balance or win display can grow with the tier. In another embodiment they can change or increase in animations. For example, at lower tiers the meters could be static, then at a higher tier they can pulsate but at an even higher tier they can begin to glow.

In one embodiment one or more payline win animations synchronize with the tier display. For example, the player wins three man symbols in the free spin so the line win animation flashes with the man tier display.

According to one embodiment, the paytable for the bonus can change with the tier. Changing the paytable could mean changing the win categories but keeping the same return to player (the win rate of the player), but it could also mean switching to a paytable with higher return to player.

In one embodiment the reel strips can change with tier such that the symbols change. This can be combined with the visual aspects of the present disclosure and have the symbols animate with the tier animation. In this embodiment the bonus game, e.g., the free spin game, could add more and more tier elements. For example, the tier display can have the elements of sword, man, red ball and coin. At first the reels may only have the sword symbol and the sword symbol interacts with the reels. As the tier level advances the red ball symbol can be added or replaced onto the reel strips and the sword and red ball can interact with the tier display.

As illustrated in FIG. 1, the gaming system 105 can be coupled with a communications network 125. The communications network 125 can comprise any one or more wired and/or wireless wide-area and/or local-area networks as known in the art including, but not limited to, the Internet. Also coupled with the network 125 can be a host system 130 comprising any one or more servers and/or other computing devices as known in the art. In one embodiment, the player can enter the bonus at the lowest tier. In another embodiment the gaming system 105 or the 130 host system can remember, e.g., in player records 135 maintained by the host system 130 or in a repository accessible by the gaming system 105, the tier state and the player enters at the state in which they last left it. This is sometimes called a persistence game.

For example, the player can use a player card to log into the gaming system 105 so the host system can know the identity of the player. Alternatively, the player could log into the system with credentials, e.g., username and password, or mobile device. When the game hits the bonus the gaming system 105 can request from the host system 130 the player's last tier saved in the player record for that player. After playing the bonus the gaming system 105 can provide the tier state to the host system 130 to update the player record 135. In some embodiments, the gaming system 105 can retrieve the tier but adjusts it when retrieving. For example, a player might reach tier level four of ten, but the next time the game resumes at level three. This could be a fixed rule, such as to lower the level by one, could be random or based on the base game trigger.

In one embodiment the triggering event on the base game can be used to determine which tier the player enters. For example, a three-symbol win might trigger the bonus at tier 1 but a five-symbol win might enter the bonus at tier 2. In one embodiment, the other symbols on the slot reels that are not be part of the winning trigger can determine the state of the tier. In one example, the player may hit three “man” symbols and triggers the bonus. On the base game reels there were three dragon symbols, so the player enters at tier 1 but with the man and the dragons.

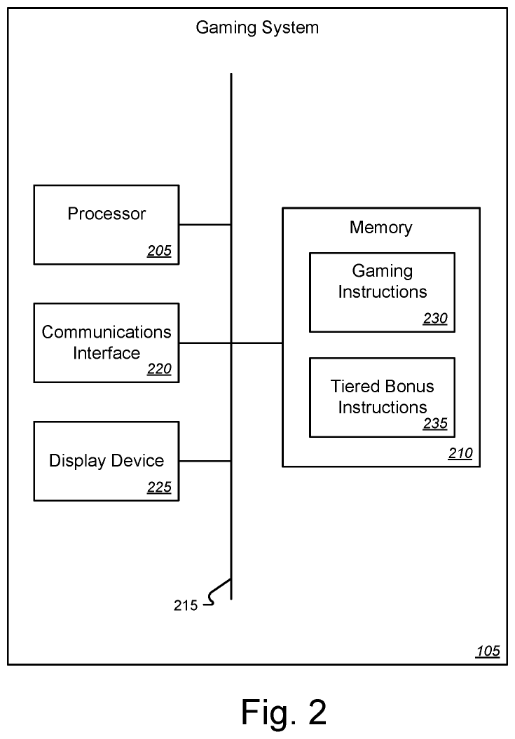

FIG. 2 is a block diagram illustrating additional details of components of an exemplary gaming system according to one embodiment of the present disclosure. As illustrated in this example, the gaming system 105 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communications interfaces 320 and a display device 225. The communication interfaces 220 can comprise, for example, Ethernet, Bluetooth, WiFi, or other type of wired or wireless communications interfaces. The display device 225 can comprise, for example, a display such as a Liquid Crystal Display (LCD), Light Emitting Diode (LED), Organic Light Emitting Diode (OLED), display or other type of display for presenting images and other graphics and can be touch sensitive allowing the user to use the display as an input device as well.

The memory 210 can store therein a set of gaming instructions 230 which, when executed by the processor 205, causes the processor 205 to execute the electronic game in a first mode of a plurality of modes. The plurality of modes can comprise the first mode and a second mode of operation of the electronic game. The second mode can comprise a plurality of tiers. For example, the first mode can comprise a base play mode of the electronic game and the second mode can comprise a bonus play mode. The electronic game can comprise an electronic slots game, a video poker game, or any of a variety of other electronic games.

The gaming instructions 230 can further cause the processor 205 to provide, through the display device 225, a graphical representation of execution of the electronic game in the first mode in a first region of a display as the game is being executed and provide, through the display device 225, a graphical representation of the second mode of operation of the electronic game a second region of the display. The graphical representation of the second mode of operation of the electronic game can comprise a representation of the current tier of the plurality of tiers. For example, the graphical indication can be related to a theme of the electronic game executed in the first mode. In some cases, the graphical indication comprises an animation.

The memory 310 can also have stored therein a set of tiered bonus instructions 235 which, when executed by the processor 205, causes the processor 205 to detect a current state of the electronic game in the first mode of the electronic game. For example, the current state of the electronic game in the first mode can comprise a win state. Based on the detected state of the electronic game, the tiered bonus instructions 235 and gaming instructions 230 can cause the processor 205 to execute the electronic game in the second mode of the plurality of modes and provide a graphical representation of execution of the electronic game in the second mode through the display device 225.

The tiered bonus instructions 235 can further cause the processor 205 to apply a tier determination rule to game play information for the electronic game executed in the second mode. For example, the electronic game can comprise an electronic slots game, the second mode of the plurality of modes can comprise a bonus game mode, i.e., a bonus spin, and the game play information for the electronic game executed in the second mode can comprise a number of free spins in the bonus game mode. Additionally, or alternatively, the game play information for the electronic game executed in the second mode can comprise an amount of time in the second mode, a speed of play for the electronic game in the second mode, and/or a result of the electronic game executed in the second mode.

The tiered bonus instructions 235 can further cause the processor 205 to update the tier of the plurality of tiers for the second mode based on the applied tier determination rule. Updating the tier of the plurality of tiers comprises incrementing the tier of the plurality of tiers or decrementing the tier of the plurality of tiers. In some cases, a paytable for the second mode of the plurality of modes of the electronic game can additionally, or alternatively, be updated based on the determined current tier of the second mode. Updating the paytable for the second mode can comprise changing win categories of the paytable and/or changing a payout of the paytable. A graphical representation of the updated tier of the plurality of tiers for the second mode can be provided through the second region of the display device.

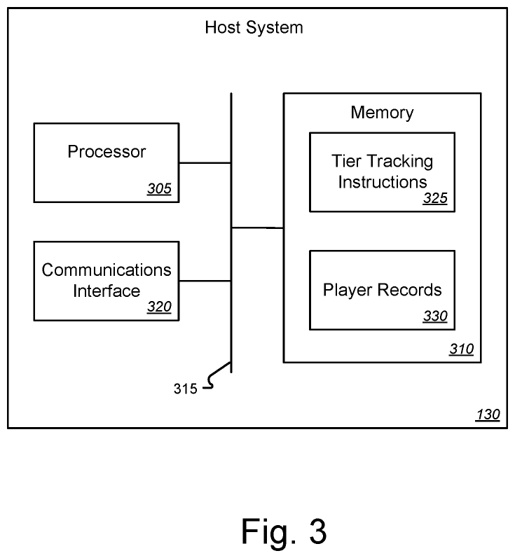

FIG. 3 is a block diagram illustrating additional details of components of an exemplary host system according to one embodiment of the present disclosure. As illustrated in this example, the host system 130 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320 via the communications bus 315. The communication interfaces 320 can comprise, for example, Ethernet, Bluetooth, WiFi, or other type of wired or wireless communications interfaces.

The memory 310 can store therein a set of tier tracking instructions 325 which, when executed by the processor 305, causes the processor 305 to maintain a set of player records 330 in which tier information for a player can be persisted. As noted, when a player begins game play on a gaming system, the current tier can be requested from a host system 130 by the gaming system. The request can identify a player of the electronic game, e.g., by a player identifier number, loyalty account number, etc. The tier tracking instructions 325 can cause the processor 305 to receive the request, retrieve the current tier for the identified player from a set of player records 330, and return the current tier to be the gaming system. During or following game play, the gaming system can also provide information indicating a change in tier level for the player, either an increase or decrease. Accordingly, the tier tracking instructions 325 can further cause the processor to receive this information and update the player records 330 accordingly.

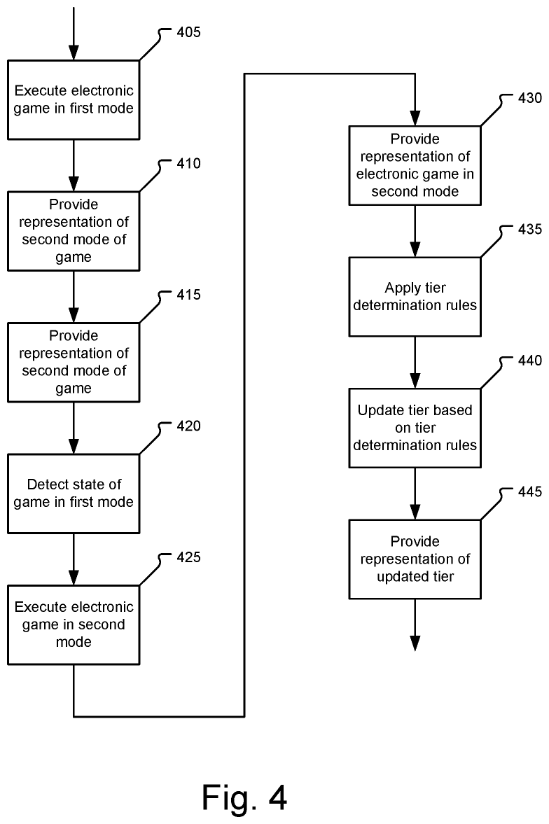

FIG. 4 is a flowchart illustrating an exemplary process for providing tiered bonuses in an electronic game according to one embodiment of the present disclosure. As illustrated in this example, the process can begin with executing 405 the electronic game in a first mode of a plurality of modes. The plurality of modes can comprise the first mode and a second mode of operation of the electronic game. The second mode can comprise a plurality of tiers. For example, the first mode can comprise a base play mode of the electronic game and the second mode can comprise a bonus play mode. The electronic game can comprise an electronic slots game, a video poker game, or any of a variety of other electronic games.

A graphical representation of execution of the electronic game in the first mode can be provided 410 through a first region of a display as the game is being executed 405. A graphical representation of the second mode of operation of the electronic game can be provided 415 through a second region of the display device. The graphical representation of the second mode of operation of the electronic game can comprise a representation of the current tier of the plurality of tiers. For example, the graphical indication can be related to a theme of the electronic game executed in the first mode. In some cases, the graphical indication comprises an animation.

A current state of the electronic game in the first mode of the electronic game can be detected 420. For example, the current state of the electronic game in the first mode can comprise a win state. Based on the detected 420 state of the electronic game, the electronic game can be executed 425 in the second mode of the plurality of modes and a graphical representation of execution of the electronic game in the second mode can be provided 430 through the first region of the display device.

A tier determination rule can be applied 435 to game play information for the electronic game executed in the second mode. For example, the electronic game can comprise an electronic slots game, the second mode of the plurality of modes can comprise a bonus game mode, i.e., a bonus spin, and the game play information for the electronic game executed in the second mode can comprise a number of free spins in the bonus game mode. Additionally, or alternatively, the game play information for the electronic game executed in the second mode can comprise an amount of time in the second mode, a speed of play for the electronic game in the second mode, and/or a result of the electronic game executed in the second mode.

The tier of the plurality of tiers for the second mode can be updated 440 based on the applied tier determination rule. Updating 440 the tier of the plurality of tiers comprises incrementing the tier of the plurality of tiers or decrementing the tier of the plurality of tiers. In some cases, a paytable for the second mode of the plurality of modes of the electronic game can additionally, or alternatively, be updated based on the determined current tier of the second mode. Updating the paytable for the second mode can comprise changing win categories of the paytable and/or changing a payout of the paytable. A graphical representation of the updated tier of the plurality of tiers for the second mode can be provided 445 through the second region of the display device.

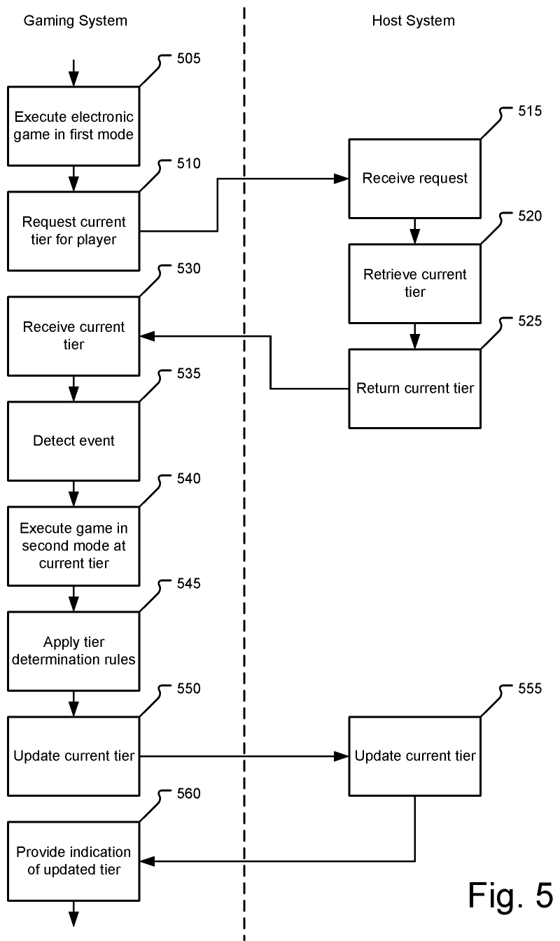

FIG. 5 is a flowchart illustrating an exemplary process for providing tiered bonuses in an electronic game according to another embodiment of the present disclosure. As illustrated in this example, the process can begin with executing 505 an electronic game in a first mode of a plurality of modes. The plurality of modes can comprise the first mode and a second mode of operation of the electronic game and the second mode can comprise a plurality of tiers. The current tier of the plurality of tiers of the second mode can be requested 510 from a host system. The request can identify a player of the electronic game. The host system can receive 515 the request, retrieve 520 the current tier for the identified player from a set of player records maintained by the host system, and return 525 the current tier to be received 530 by the gaming system.

During execution of the electronic game, an occurrence of an event can be detected 535 in the first mode of the electronic game. Based on the detected 535 occurrence of the event, the electronic game can be executed 540 in the second mode of the plurality of modes at the current tier. A tier determination rule can be applied 545 to game play information for the electronic game executed in the second mode and the tier of the plurality of tiers for the second mode updated 550 and 555 on the gaming system and host system based on the applied tier determination rule. An indication of the updated tier of the plurality of tiers for the second mode can be provided, e.g., through a display device of the gaming system as described above.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A gaming system comprising:
a processor; and
a memory coupled with and readable by the processor and storing therein a set of instructions which, when executed by the processor, causes the processor to:
execute an electronic game in a first mode of the plurality of modes;
detect an occurrence of an event in the first mode of the electronic game;
execute the electronic game in a second mode of the plurality of modes based on the detected occurrence of the event, wherein the second mode of the plurality of modes comprises a tier of a plurality of tiers;
apply a tier determination rule to game play information for the electronic game executed in the second mode;
update the tier of the plurality of tiers for the second mode based on the applied tier determination rule; and
provide an indication of the updated tier of the plurality of tiers for the second mode.

2. The gaming system of claim 1, further comprising a display device coupled with the processor and wherein providing the indication of the updated tier of the plurality of tiers for the second mode comprises presenting a graphical indication of the updated tier of the display device.

3. The gaming system of claim 2, wherein the graphical indication is related to a theme of the electronic game executed in the first mode.

4. The gaming system of claim 2, wherein the graphical indication comprises an animation.

5. The gaming system of claim 1, wherein the first mode comprises a base play mode of the electronic game and the second mode comprises a bonus play mode.

6. The gaming system of claim 5, wherein the electronic game comprises an electronic slots game.

7. The gaming system of claim 1, wherein the electronic game comprises a video poker game.

8. A gaming system comprising:
a display device;
a processor coupled with the display device; and
a memory coupled with and readable by the processor and storing therein a set of instructions which, when executed by the processor, causes the processor to:
execute an electronic game in a first mode of a plurality of modes, the plurality of modes comprising the first mode and a second mode of operation of the electronic game, the second mode comprising a plurality of tiers;
provide a graphical representation of execution of the electronic game in the first mode through a first region of the display device;
provide a graphical representation of the second mode of operation of the electronic game through a second region of the display device;
detect a current state of the electronic game in the first mode of the electronic game;
execute the electronic game in a second mode of the plurality of modes based on the detected state of the electronic game;
provide a graphical representation of execution of the electronic game in the second mode through the first region of the display device;
apply a tier determination rule to game play information for the electronic game executed in the second mode;
update the tier of the plurality of tiers for the second mode based on the applied tier determination rule; and
provide a graphical representation of the updated tier of the plurality of tiers for the second mode through the second region of the display device.

9. The gaming system of claim 8, wherein updating the tier of the plurality of tiers comprises incrementing the tier of the plurality of tiers.

10. The gaming system of claim 8, wherein updating the tier of the plurality of tiers comprises decrementing the tier of the plurality of tiers.

11. The gaming system of claim 8, wherein the state of the electronic game in the first mode comprises a win state.

12. The gaming system of claim 8, wherein the electronic game comprises an electronic slots game, wherein the second mode of the plurality of modes comprises a bonus game mode, and the game play information for the electronic game executed in the second mode comprises a number of free spins in the bonus game mode.

13. The gaming system of claim 8, wherein the game play information for the electronic game executed in the second mode comprises an amount of time in the second mode.

14. The gaming system of claim 8, wherein the game play information for the electronic game executed in the second mode comprises a speed of play for the electronic game in the second mode.

15. The gaming system of claim 8, wherein the game play information for the electronic game executed in the second mode comprises a result of the electronic game executed in the second mode.

16. A method of executing an electronic game on a gaming system, the method comprising:
executing, by the gaming system, the electronic game in a first mode of a plurality of modes, the plurality of modes comprising the first mode and a second mode of operation of the electronic game, the second mode comprising a plurality of tiers;
providing, by the gaming system, a graphical representation of execution of the electronic game in the first mode through a first region of a display device of the gaming system;
determining, by the gaming system, a current tier of the plurality of tiers for the second mode;
providing, by the gaming system, a graphical representation of the second mode of operation of the electronic game through a second region of the display device, the graphical representation of the second mode of operation of the electronic game comprising a representation of the current tier of the plurality of tiers;
detecting, by the gaming system, a current state of the electronic game in the first mode of the electronic game;
executing, by the gaming system, the electronic game in a second mode of the plurality of modes based on the detected state of the electronic game;
providing, by the gaming system, a graphical representation of execution of the electronic game in the second mode through the first region of the display device;
applying, by the gaming system, a tier determination rule to game play information for the electronic game executed in the second mode;
updating, by the gaming system, the tier of the plurality of tiers for the second mode based on the applied tier determination rule; and
providing, by the gaming system, a graphical representation of the updated tier of the plurality of tiers for the second mode through the second region of the display device.

17. The method of claim 16, wherein determining the current tier of the plurality of tiers of the second mode comprises requesting, from a host system, the current tier of the plurality of tiers of the second mode.

18. The method of claim 16, further comprising updating, by the gaming system, a paytable for the second mode of the plurality of modes of the electronic game based on the determined current tier of the second mode.

19. The method of claim 18, wherein updating the paytable for the second mode comprises changing win categories of the paytable.

20. The method of claim 18, wherein updating the paytable for the second mode comprises changing a payout of the paytable.
